(19) United States
(12) Patent Application Publication
(10) Pub. No.: US 2020/0189246 A1
(43) Pub. Date: Jun. 18, 2020

(54) MULTILAYER RECYCLABLE ULTRASONICALLY WELDED FILMS

(71) Applicant: Campbell Soup Company, Camden, NJ (US)

(72) Inventors: Hua Liu, Moorestown, NJ (US); Mark Robert Watts, Marlton, NJ (US); Rasheed Mohammed, Sicklerville, NJ (US)

(21) Appl. No.: 16/682,114

(22) Filed: Nov. 13, 2019

Related U.S. Application Data
(60) Provisional application No. 62/760,355, filed on Nov. 13, 2018.

(51) Int. Cl. B32B 27/08; B32B 27/18

(52) U.S. Cl. CPC B32B 27/08; B32B 27/18; B32B 2250/03; B32B 2250/05; B32B 2307/7242; B32B 2439/70; B32B 2307/74

(57) ABSTRACT

Embodiments herein relate to multilayer recyclable films for food packaging. In an embodiment, a multilayer packaging film is included with a first polymeric layer, a second polymeric layer, and a third polymeric layer. The first layer and the third layer can directly contact opposite sides of the second layer. The first layer and the third layer can be directly bonded to the second layer via a welding process. The first polymeric layer, the second polymeric layer, and the third polymeric layer can each contain the same thermoplastic polymer. The second polymeric layer can include an amount of a functional additive that is different than the first and third polymeric layers. Other embodiments are also included herein.

This application claims the benefit of U.S. Provisional Application No. 62/760,355, filed Nov. 13, 2018, the content of which is herein incorporated by reference in its entirety.

### FIELD

Embodiments herein relate to multilayer recyclable films for food packaging.

### BACKGROUND

Many food packaging film materials are of a multilayer design. A typical five-layer structured multifilm includes an inner layer of polyamide (PA) between two tie layers adhering two outer skin layers of polypropylene (PP) to either side of the inner layer. The outer skin layers can provide strength and toughness characteristics to the overall structure and protection to the inner layers. The inner layer can also provide strength and toughness characteristics and additionally, other important physical and chemical characteristics, such as barrier performance against permeation of oxygen and moisture.

In order to bond these layers of chemically dissimilar materials together, special adhesive layers or tie layers are needed. Common tie layer materials include ethylene vinyl acetate (EVA), ethylene methyl acrylate (EMA), ethylene acrylic acid (EAA), ethylene methacrylic acid (EMAA), and maleic anhydride grafted polyethylene (MAH-g-PE), amongst others.

### SUMMARY

Embodiments herein relate to multilayer recyclable films for food packaging. In an embodiment, a multilayer packaging film is included with a first polymeric layer, a second polymeric layer, and a third polymeric layer. The first layer and the third layer can directly contact opposite sides of the second layer. The first layer and the third layer can be directly bonded to the second layer via a welding process. The first polymeric layer, the second polymeric layer, and the third polymeric layer can each contain the same thermoplastic polymer. The second polymeric layer can include an amount of a functional additive that is different than the first and third polymeric layers.

In an embodiment, a method of manufacturing a multilayer packaging film is included herein. The method can include coextruding at least two layers of a multilayer packaging film. The multilayer packaging film can include a first polymeric layer, a second polymeric layer, and a third polymeric layer. The first layer and the third layer can directly contact opposite sides of the second layer. The first layer and the third layer can be directly bonded to the second layer via a welding process. The first polymeric layer, the second polymeric layer, and the third polymeric layer can each comprise the same thermoplastic polymer. The second polymeric layer can include a weight percent amount of a functional additive that is different than the first and third polymeric layers. The method can further include welding the first polymeric layer, the second polymeric layer, and the third polymeric layer directly together.

In an embodiment, a packaged food product is included. The packaged food product can include a package formed of a multilayer packaging film. The multilayer packaging film can include a first polymeric layer, a second polymeric layer, and a third polymeric layer. The first layer and the third layer can directly contact opposite sides of the second layer. The first layer and the third layer can be directly bonded to the second layer via a welding process. The first polymeric layer, the second polymeric layer, and the third polymeric layer can each include the same thermoplastic polymer. The second polymeric layer can include a weight percent amount of a functional additive that is different than the first and third polymeric layers. The packaged food product can further include a food material disposed in the package.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a front view of a packaged food product in accordance with various embodiments herein.

FIG. 2 is a schematic cross-sectional view of a packaged food product in accordance with various embodiments herein.

FIG. 3 is a cross-sectional view of multilayer film of a package in accordance with various embodiments herein.

FIG. 4 is a cross-sectional view of multilayer film of a package in accordance with various embodiments herein.

FIG. 5 is a schematic of a manufacturing system in accordance with various embodiments herein.

FIG. 6 is a schematic of a manufacturing system in accordance with various embodiments herein.

FIG. 7 is a cross-sectional view of multilayer film of a package in accordance with various embodiments herein.

FIG. 8 is a cross-sectional view of multilayer film of a package in accordance with various embodiments herein.

FIG. 9 is a cross-sectional view of multilayer film of a package in accordance with various embodiments herein.

FIG. 10 is a cross-sectional view of multilayer film of a package in accordance with various embodiments herein.

FIG. 11 is a cross-sectional view of multilayer film of a package in accordance with various embodiments herein.

FIG. 12 is a cross-sectional view of multilayer film of a package in accordance with various embodiments herein.

FIG. 13 is a flow chart of a method in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Various food packaging products include multilayer films. The various layers making up a multilayer film can provide different functionalities. For example, some layers can provide strength and toughness, and other layers can provide a barrier against oxygen and moisture ingress. However, frequently, multilayer films include the use of dissimilar materials that are tightly bonded together and cannot be easily separated in the conventional recycling process. Thus, existing constructions of multilayer films can present a great challenge to the recyclability of these multilayer packaging materials.

The multilayer films described herein can include one or more desired function properties, as well as being fully recyclable. Various embodiments described herein include multilayer films which do not include adhesives or tie layers, allowing the films to be easily recycled. Various embodiments include similar (or the same) polymers for each of the layers to also allow for easy recycling of the multilayer films. Numerous embodiments include fully recyclable food packing film wherein discrete layers thereof are attached together through ultrasonic welding.

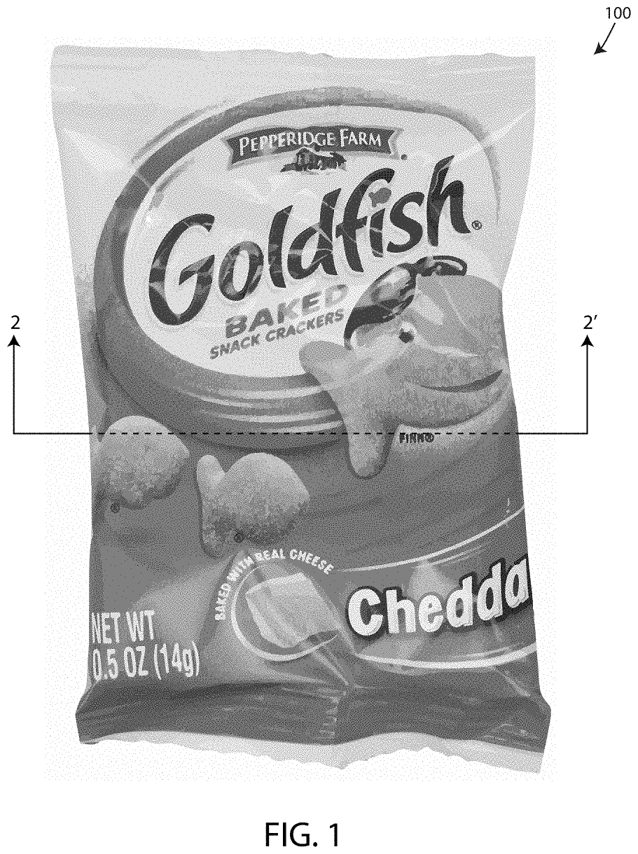

Referring now to FIG. 1, a front view of a packaged food product 100 is shown in accordance with various embodiments herein. The packaged food product 100 can include a multilayer packaging film defining an interior volume. A food material can be disposed within the interior volume.

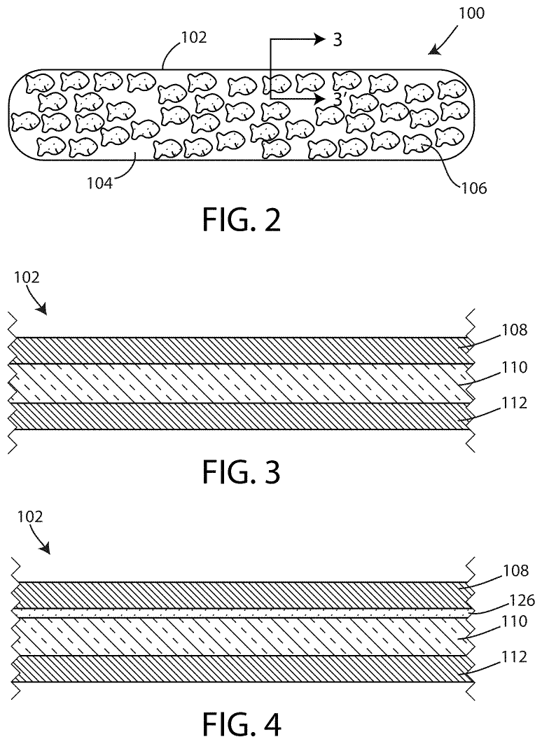

FIG. 2 shows a cross-sectional view of the packaged food product 100 shown in FIG. 1 along line 2-2 accordance with various embodiments herein. The packaged food product 100 can include a multilayer packaging film 102 defining an interior volume 104. The food material 106 can be disposed within the interior volume 104.

In reference now to FIG. 3, a cross-sectional view of the multilayer packaging film 102 of a package is shown in accordance with various embodiments herein. The multilayer packaging film 102 can include a first polymeric layer 108, a second polymeric layer 110, and a third polymeric layer 112.

The second polymeric layer 110 can be disposed between the first polymeric layer 108 and the third polymeric layer 112. The first polymeric layer 108 and the third polymeric layer 112 can directly contact opposite sides of the second polymeric layer 110. In various embodiments, the first polymeric layer 108 and the third polymeric layer 112 can directly contact the second polymeric layer 110, such that the first polymeric layer 108 and the second polymeric layer 110 physically interact or touch each other, and the third polymeric layer 112 and the second polymeric layer 110 physically interact or touch each other.

The first polymeric layer 108 and the second polymeric layer 110 can be directly bonded, such as via a welding process. Similarly, the third polymeric layer 112 and the second polymeric layer 110 can be directly bonded as well. The layers can be directly bonded, such that there is not an intervening layer, a tie layer, adhesives or any other components disposed between the layers. In various embodiments, the multilayer packaging film 102 is uncoated, such that the outer layers are uncovered or exposed to the surrounding environment. However, in other embodiments, the multilayer packaging film 102 (or discrete components thereof) may be coated, such that one or more exterior surfaces of the outer layers are covered with another material, such as a high gloss or matte overprint varnish, or the like.

In various embodiments, the first polymeric layer 108, the second polymeric layer 110, and the third polymeric layer 112 each include the same thermoplastic polymer. The second polymeric layer 110 can include a weight percent amount of a functional additive that is different than the first polymeric layer 108 and the third polymeric layer 112. In some embodiments, the multilayer packaging film 102 can be asymmetric, such as the layers having different additives or different amounts of additives. In additional embodiments, the asymmetric multilayer packaging film 102 can include layers that have different thicknesses, such as shown in FIG. 8 and discussed below.

In various embodiments, the multilayer packaging film 102 exhibits an enhanced functional property, including one or more of strength, toughness, impact resistance, fracture resistance, and conductivity compared with an otherwise identical multilayer packaging film lacking the functional additives.

In some embodiments, the multilayer packaging film 102 exhibits an oxygen transmission rate (OTR) of less than 100 cc/100 in²-day at 73° F., 0% RH, and 1 atm as measured per ASTM D3985. In some embodiments, the multilayer packaging film 102 exhibits an OTR of less than 10 cc/100 in²-day at 73° F., 0% RH, and 1 atm as measured per ASTM D3985. In other embodiments, the multilayer packaging film 102 exhibits an OTR of less than 1 cc/100 in²-day at 73° F., 0% RH, and 1 atm as measured per ASTM D3985. In other embodiments, the multilayer packaging film 102 exhibits an OTR of less than 0.001 cc/100 in²-day at 73° F., 0% RH, and 1 atm as measured per ASTM D3985, for a period of at least one week of exposure. In some embodiments, the multilayer packaging film 102 exhibits an OTR falling within a range between any of the foregoing.

In some embodiments, the multilayer packaging film 102 exhibits a water vapor transmission rate (WVTR) of less than 10 cc/100 in²/day at 100° F., 90% RH as measured per ASTM F1249. In other embodiments, the multilayer packaging film 102 exhibits a WVTR of less than 1 cc/100 in²/day at 100° F., 90% RH as measured per ASTM F1249. In other embodiments, the multilayer packaging film 102 exhibits a WVTR of less than 0.1 cc/100 in²/day at 100° F., 90% RH as measured per ASTM F1249. In some embodiments, the multilayer packaging film 102 exhibits a WVTR falling within a range between any of the foregoing.

FIG. 4 shows a cross-sectional view of multilayer packaging film 102 of a package is shown in accordance with various embodiments herein. In some embodiments, the multilayer packaging film 102 can include graphic components 126. The graphic components 126 can be disposed on, in, or under the first polymeric layer 108. In the example of FIG. 4, the graphic components 126 are between the first polymeric layer 108 and the second polymeric layer 110. As such, in this example the graphic components 126 are reverse printed (or subsurface printed), such that the ink is covered by the first polymeric layer 108 for scuff resistance. When disposed between the first polymeric layer 108 and the second polymeric layer 110, the graphic components 126 do not interfere with ultrasonic welding of the first polymeric layer 108 and the second polymeric layer 110. In some cases, the graphic components 126 could also be disposed to the outside of the first polymeric layer 108 or even within the first polymeric layer 108 (or another layer herein). The graphic components 126 can include designs, information, or other aspect that are to be relayed visually. The graphic components 126 can include inks, pigments, binders, and the like.

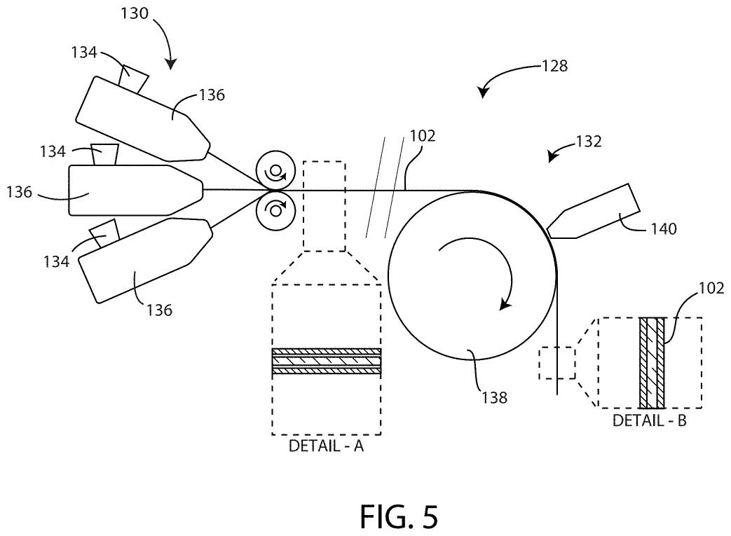

Referring now to FIG. 5, a schematic of a manufacturing system 128 is shown in accordance with various embodiments herein. The manufacturing system 128 can be configured to manufacture or create the multilayer film. The manufacturing system 128 can include an extrusion portion 130 and a welding portion 132. The manufacturing system 128 can extrude one or more layers of the multilayer film and bond the layers together, such as by ultrasonically welding the layers together.

The manufacturing system 128 can include extruders 136. Each extruder can include one or more material input hoppers 134 for raw material inputs. Each extruder 136 can extrude a sheet of material. In FIG. 5, three layers are being separately extruded and then stacked, such as shown in the detail view A. In some embodiments, one or more layers can be extruded at a different location, such as at a different location within the same manufacturing facility or at a different manufacturing facility and transported to the facility with the manufacturing system 128.

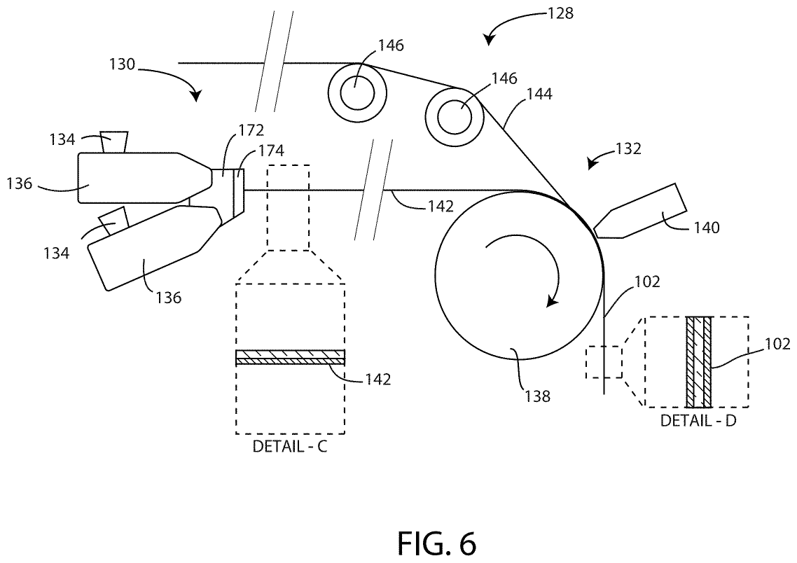

It will be appreciated that in some embodiments, multiple layers of the film can be coextruded, such that they are extruded simultaneously (such as the two layers coextruded as shown in FIG. 6 discussed further below). In some embodiments, at least two layers of the multilayer film are coextruded. In some embodiments, all of the layers of the multilayer film are coextruded.

Many different types of extruders can be used in embodiments herein including, but not limited to, single-screw extruders, twin-screw extruders, and the like.

The manufacturing system 128 can include an anvil roller 138 (or other anvil device) and a sonotrode 140. After the layers are extruded and the layers are stacked, the can then pass between the anvil roller 138 and the sonotrode 140. The sonotrode 140 can be configured to create ultrasonic vibrations and apply the vibrations to the layers, thereby bonding the layers together through a welding mechanism. The first layer and the third layer can be directly bonded to the second layer via an ultrasonic welding process, such as shown in the detail view B.

Referring now to FIG. 6, a schematic view of a manufacturing system 128 is shown in accordance with various embodiments herein. In some embodiments, the manufacturing system 128 can include extruders 136 with hoppers 134. The melt streams from the extruders 136 can feed into a feed block 172 and then extruded materials can pass out through a die 174 coextruding two layers 142 of the multilayer film, such as shown in the detailed view C.

In some embodiments, at least one layer 144, such as one of the first polymeric layer, the second polymeric layer, or the third polymeric layer is separately placed onto the other two layers after the other two layers are coextruded. In some embodiments, the third layer can be added to the first and second layers, when the first and second layers are coextruded without the third layer. In some embodiments, the added layer(s) 144 can be extruded at a different location, such as at a different location within the same manufacturing facility or at a different manufacturing facility and transported to the facility with the manufacturing system 128. In some embodiments, the polymeric layer 144 can be further treated or printed (including surface printed on a top surface or reverse printed on a bottom surface) before it is placed (stacked) onto the other layers.

The added layer 144 can be fed onto the two layers 142, such as with a feed system including one or more rollers 146. The layers 142, 144 (both the coextruded layers 142 and the added layer(s) 144) can be bonded together via an ultrasonic welding process. The layers 142, 144 can be fed between an anvil roller 138 and a sonotrode 140. After passing through the anvil roller 138 and the sonotrode 140, the multilayer packaging film 102 can include three bonded layers, such as shown in the detailed view D.

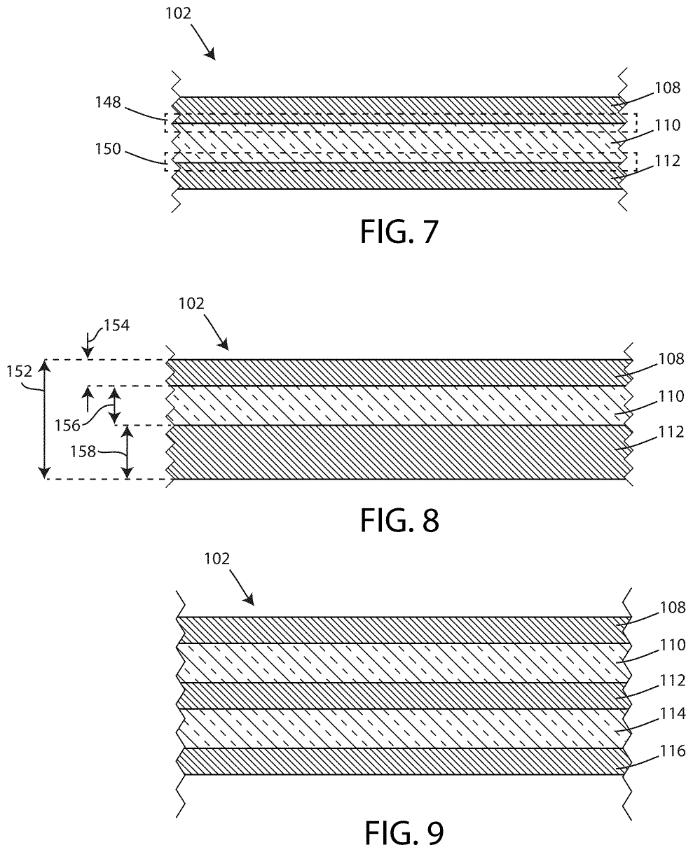

Referring now to FIG. 7, a cross-sectional view of multilayer packaging film 102 of a package is shown in accordance with various embodiments herein. The bonding or welding of the layers can result in the zones 148, 150 at the interface near and between two bonded layers. The zones 148, 150 can exhibit different properties than the layers did prior to the bonding or different properties than the portion of the layers that are outside of the zones 148, 150. The differences of the zone can include differing density, crystallinity, optical clarity, stiffness, a mechanical property, a rheological property, or an optical property. In some embodiments, the zones 148, 150 can result from the bonding of the two adjacent layers, such as through ultrasonic welding.

In some embodiments, the multilayer packaging film 102 can include at least two distinct zones 148, 150. Each of the zones 148, 150 can overlap the interface or bond between two adjacent layers. The first zone 148 can overlap the bond between the first polymeric layer 108 and the second polymeric layer 110, the second zone 150 can overlap the bond between the second polymeric layer 110 and the third polymeric layer 112. Further, multilayer films with more than three layers can have more than two zones. For example, a six layer film can have five zones, and a nine layer film can have eight zones.

Referring now to FIG. 8, a cross-sectional view of multilayer packaging film 102 is shown in accordance with various embodiments herein. In some embodiments, the thickness 152 of the multilayer packaging film 102 is at least about 20 microns and not more than about 200 microns.

In some embodiments, the thickness 154 of the first polymeric layer 108 is not less than about 10 microns and not more than about 50 microns. In some embodiments, the thickness 156 of the second polymeric layer 110 is not less than about 10 microns and not more than 150 microns. In some embodiments, the thickness 158 of the third polymeric layer 112 is not less than about 10 microns and not more than 50 microns.

In some embodiments, the thickness 154 of the first polymeric layer 108 is equivalent to the thickness 158 of the third polymeric layer 112. In some embodiments, the thickness 154 of the first polymeric layer 108 is equivalent to the thickness 156 of the second polymeric layer 110. In some embodiments, the thickness 156 of the second polymeric layer 110 is equivalent to the thickness 158 of the third polymeric layer 112.

In some embodiments, the multilayer packaging film 102 is asymmetric in layer thickness, such that at least two of the layers have different thicknesses. In other embodiments, three layers have different thicknesses. In other embodiments, all of the layers have different thicknesses.

In some embodiments, the thickness 154 of the first polymeric layer 108 is less than the thickness 156 of the second polymeric layer 110 and/or the thickness 158 of the third polymeric layer 112. In some embodiments, the thickness 156 of the second polymeric layer 110 is less than the thickness 154 of the first polymeric layer 108 and/or the thickness 158 of the third polymeric layer 112. In some embodiments, the thickness 156 of the second polymeric layer 110 is less than the thickness 154 of the first polymeric layer 108 and/or the thickness 158 of the third polymeric layer 112.

In some embodiments, the thickness 154 of the first polymeric layer 108 is different than the thickness 156 of the second polymeric layer 110 by at least 50%. In some embodiments, the thickness 154 of the first polymeric layer 108 is different than the thickness 156 of the second polymeric layer 110 by at least 200%.

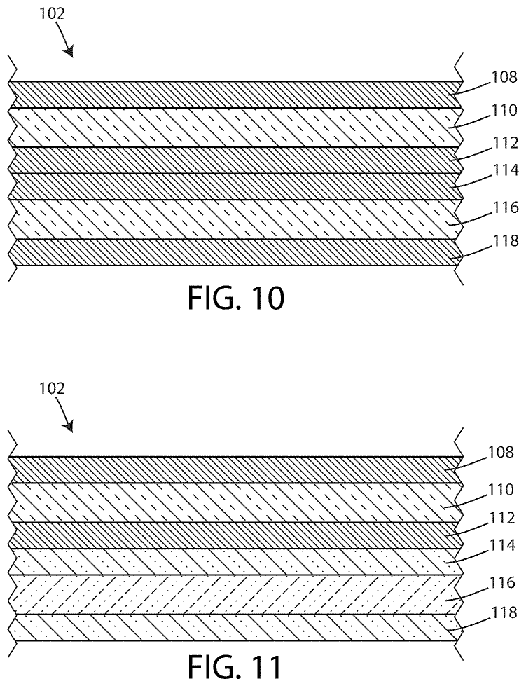

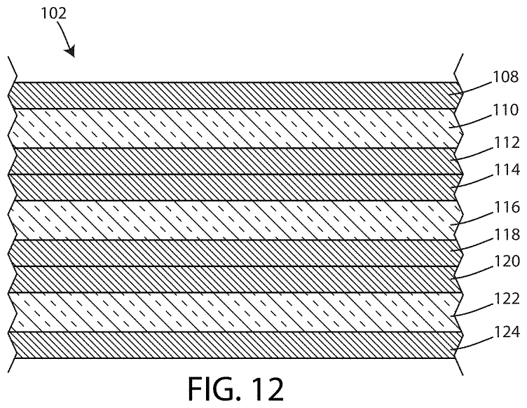

Various embodiments of the multilayer film can include different amounts of layers. FIG. 3 shows an embodiment with three layers. FIG. 9 shows an embodiment with five layers. FIGS. 10 and 11 show embodiments with six layers. FIG. 12 shows an embodiment with nine layers.

Referring now to FIG. 9, the multilayer packaging film 102 can include five layers in accordance with various embodiments herein. The first polymeric layer 108 and the third polymeric layer 112 can be directly bonded to the second polymeric layer 110. The third polymeric layer 112 and the fifth polymeric layer 116 can be directly bonded to the fourth polymeric layer 114. In some embodiments, the second polymeric layer 110 and the fourth polymeric layer 114 can include different functional additives and/or different amounts of the same functional additives than the first polymeric layer 108, the third polymeric layer 112, and the fifth polymeric layer 116. In some embodiments, the first polymeric layer 108 can be equivalent to the third polymeric layer 112 and/or the fifth polymeric layer 116. In some embodiments, the second polymeric layer 110 can be equivalent to the fourth polymeric layer 114.

In some embodiments, the multilayer packaging film 102 can include six layers, such as shown in FIGS. 10 and 11. The multilayer packaging film 102 can include a first polymeric layer 108, a second polymeric layer 110, a third polymeric layer 112, a fourth polymeric layer 114, a fifth polymeric layer 116, and a sixth polymeric layer 118. The first polymeric layer 108 and the third polymeric layer 112 can contact the second polymeric layer 110, and the fourth polymeric layer 114 and the sixth polymeric layer 118 can contact the fifth polymeric layer 116. The fourth polymeric layer 114 can contact the first polymeric layer 108 or the third polymeric layer 112, or the sixth polymeric layer 118 can contact the first polymeric layer 108 or the third polymeric layer 112.

Various combinations of the six polymeric layers are possible. In some embodiments, the fourth polymeric layer 114 can be the same as the first polymeric layer 108, such as shown in FIG. 10. Additionally, the fifth polymeric layer 116 can be the same as the second polymeric layer 110. Further, the sixth polymeric layer 118 can be the same as the third polymeric layer 112. In other embodiments, each of the polymeric layers can be unique. In further embodiments, the first polymeric layer 108 can be the same as the third polymeric layer 112, and the fourth polymeric layer 114 can be the same as the sixth polymeric layer 118, such as shown in FIG. 11.

FIG. 12 shows a cross-sectional view of the multilayer packaging film 102 with nine layers in accordance with various embodiments herein. The multilayer packaging film 102 can further include a seventh polymeric layer 120, an eighth polymeric layer 122, and a ninth polymeric layer 124. In some embodiments, the seventh polymeric layer 120 can contact the first polymeric layer 108, the third polymeric layer 112, the fourth polymeric layer 114, or the sixth polymeric layer 118. In some embodiments, the ninth polymeric layer 124 can contact the first polymeric layer 108, the third polymeric layer 112, the fourth polymeric layer 114, or the sixth polymeric layer 118.

In various embodiments, the seventh polymeric layer 120 can be the same as the first polymeric layer 108, the eighth polymeric layer 122 can be the same as the second polymeric layer 110, and the ninth polymeric layer 124 can be the same as the third polymeric layer 112. In some embodiments, the seventh polymeric layer 120 can be the same as the ninth polymeric layer 124.

### Methods

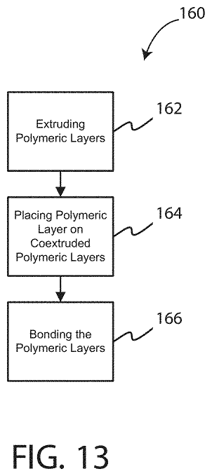

Referring now to FIG. 13, a flow chart of a method 160 of manufacturing a packaging film is shown in accordance with various embodiments herein. The method 160 can include coextruding at least two layers of a multilayer packaging film 162. In some embodiments, the method 160 can include coextruding at least three layers, at least four layers, at least five layer, at least six layers, at least seven layers, at least eight layers, or at least nine layers. The multilayer packaging film can be as describe herein. The multilayer packaging film can include a first polymeric layer, a second polymeric layer, and a third polymeric layer.

In some embodiments, the method 160 can further include placing additional layers on to the two or more layers that were coextruded 164. For example, in some embodiments, the first polymeric layer and the second polymeric layer can be coextruded, and the third polymeric layer can be placed onto the other two layers after they have been coextruded.

The method 160 can further include welding multiple layers together 166. In some embodiments, the welding can include ultrasonic welding. In some embodiments, the first polymeric layer, the second polymeric layer, and the third polymeric layer are welded directly together. Additional layers can also be welded simultaneously with the first three layers. In some embodiments, the method can also include a step of reverse printing or otherwise depositing graphic components onto a layer, which can happen before the operation of welding the multiple layers together 166.

### Layer Polymers

In various embodiments, each of the layers can include a polymer, such as a thermoplastic polymer. Polymers can include, but are not limited to, polyolefins, polyethylene terephthalate, polystyrene, polyvinyl chloride, polycarbonate, ABS, polyamides, polyphenylene sulfide, PMMA, and the like. In various embodiments, the thermoplastic polymer can include homopolymers or copolymers of high density polyethylene (HDPE), low density polyethylene (LDPE) (PE molecular weight of repeat unit 28.05 g/mol as one specific example), polypropylene (PP, molecular weight of repeat unit 42.08 g/mol as one specific example), polyethylene terephthalate (PET molecular weight of repeat unit 192.2 g/mol as one specific example), polystyrene (PS including high impact polystyrene (HIPS), PS molecular weight of repeat unit 104.1 g/mol as one specific example), polyvinyl chloride (PVC, molecular weight of repeat unit 62.5 g/mol as one specific example), polycarbonate (PC, molecular weight of repeat unit 290.315 g/mol as one specific example), acrylonitrile butadiene styrene (ABS, molecular weight of repeat unit 211.308 g/mol as one specific example), polyamide (PA, molecular weight of repeat unit 341.496 g/mol as one specific example), polyphenylene sulfide (PPS, molecular weight of repeat unit 108.16 g/mol as one specific example), poly(methyl methacrylate) (PMMA, molecular weight of repeat unit 100.12 g/mol as one specific example), and the like.

Each of the polymeric layers can include the same polymer. In various embodiments, the melt flow properties of the thermoplastic polymer in the second polymeric layer can be the same as the melt flow properties of the thermoplastic polymer in the first polymeric layer and/or the third polymeric layer. In some embodiments, the average molecular weight of the thermoplastic polymer in the second polymeric layer can be the same as the average molecular weight of the thermoplastic polymer in the first polymeric layer and the third polymeric layer. In some embodiments, the average molecular weight of the thermoplastic polymer in the second polymeric layer can be different than the average molecular weight of the thermoplastic polymer in the first polymeric layer and the third polymeric layer.

In some embodiments, the thermoplastic polymer in the second polymeric layer exhibits a process induced polymer chain orientation that can be different than a polymer chain orientation in the first polymeric layer and the third polymeric layer. In other embodiments, the thermoplastic polymer in the second polymeric layer exhibits a process-induced polymer chain orientation that can be the same as a polymer chain orientation in the first polymeric layer and the third polymeric layer.

### Functional Additives

As mentioned above, one or more of the layers can include a functional additive. As used herein, the term “functional additive” shall refer to additives included with a polymeric composition in order to provide a functional property to a layer made with the polymeric composition. The term “functional additive” does not include normal processing aids known to those of skill in that art that are added to assist with the extrusion process. The functional additive can include one or more of the following a barrier additive, an oxygen scavenger, a desiccant, a clarifying agent, a nucleator, a pigment, a dye, a UV stabilizer, a UV blocker, an optical brightener, an impact modifier, a slip agent, an antiblock agent, a reinforcing additive, a plasticizer, an electrical conductivity enhancer, and a thermal conductivity enhancer. In some embodiments, the second polymeric layer can include a second functional additive. In some embodiments, the first polymeric layer, the third polymeric layer, and/or other layers can include a second functional additive.

In some embodiments, the oxygen scavenger can include an oxidizable polymer and a transition metal salt catalyst. In some embodiments, the oxygen scavenger can include poly(tetramethylene ether)-b-PET block copolymer (PTMEG-b-PET). In some embodiments, the oxygen scavenger can include m-xylylene diamine adipate with a cobalt salt catalyst. In some embodiments, the oxygen scavenger can include an oxidizable ethylene terpolymer such as ethylene methylacrylate cyclohexenylmethyl acrylate (EMCM), poly(ethylene/vinyl cyclohexene) (EVCH), poly(cyclohexene methyl methacrylate), (CHMA), and poly(cyclohexene methyl acrylate) (CHAA), with a cobalt salt catalyst.

### Layer Compositions

One or more of the layers can include a weight percent amount of a functional additive. In some embodiments, the second layer can include a weight percent amount of a functional additive that is different than the first and third polymeric layers. In some embodiments, the total loading of functional additives in the first polymeric layer, the second polymeric layer, or third polymeric layer can be greater than 1 wt. % and less than 20 wt. %.

In some embodiments, the second polymeric layer can include a weight percent amount of a functional additive that is at least 50% greater than the first and third polymeric layers. In some embodiments, the second polymeric layer can include a weight percent amount of a functional additive that is at least 100% greater than the first and third polymeric layers. In some embodiments, the second polymeric layer can include a weight percent amount of a functional additive that is at least 200% greater than the first and third polymeric layers.

In some embodiments, the second polymeric layer can include at least about 0.01 wt. percent of the functional additive. In some embodiments, the second polymeric layer can include at least about 0.01 wt. percent of a functional additive and the first and third polymeric layers can include less than 0.01 wt. percent of the functional additive. In some embodiments, the second polymeric layer can include at least about 1.0 wt. percent of the functional additive. In some embodiments, the first and third polymeric layers comprise a least one functional additive in common with the second polymeric layer, but at a lower wt. % concentration.

In some embodiments, the first and third polymeric layers each can include at least one functional additive. The functional additive of the first polymeric layer and the functional additive the third polymeric layer can both be different than the functional additives in the second polymeric layer. In some embodiments, the functional additive of the first polymeric layer and the functional additive of the third polymeric layer can be different from one another. In some embodiments, the first polymeric layer and the third polymeric layer lack the functional additive of the second polymer layer.

### Extrusion

As described above, one or more of the layers can be extruded. In some embodiments, the layer is pushed through a die to obtain a consistent cross-section. In other embodiments, the layer can be pulled or drawn through the die.

In some embodiments, one or more layers can be coextruded, such that the one or more layers are extruded simultaneously. In various embodiments, the extrusion process can include sheet extrusion to result in an extruded layer that has a length and width which are each at least 10 times greater than the thickness of the layer

The extrusion process can include raw polymer, such as polymer pellets, flakes, powders, granules, or chips, loaded into one or more hoppers. The polymer can be fed via a feeding mechanism, such as a screw drive. The raw polymer can be melted such as through mechanical energy in a screw drive and/or with heaters arranged along the system. The molten polymer can be forced into and through a die, which can shape the polymer into the desired configured.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A multilayer packaging film comprising:
a first polymeric layer;
a second polymeric layer; and
a third polymeric layer;
wherein the first layer and the third layer directly contact opposite sides of the second layer;
wherein the first layer and the third layer are directly bonded to the second layer via a welding process;
wherein the first polymeric layer, the second polymeric layer, and the third polymeric layer each comprise the same thermoplastic polymer;
wherein the second polymeric layer comprises a weight percent amount of a functional additive that is different than the first and third polymeric layers.

2. The multilayer packaging film of claim 1, wherein the second polymeric layer comprises a weight percent amount of a functional additive that is at least 50% greater than the first and third polymeric layers.

3-5. (canceled)

6. The multilayer packaging film of claim 1, wherein the functional additive is selected from the group consisting of a barrier additive, an oxygen scavenger, a dessicant, a clarifying agent, a nucleator, a pigment, a dye, a UV stabilizer, a UV blocker, an optical brightener, an impact modifier, a slip agent, an antiblock agent, a reinforcing additive, a plasticizer, an electrical conductivity enhancer, and a thermal conductivity enhancer.

7. The multilayer packaging film of claim 1, wherein the functional additive comprises an oxygen scavenger, the oxygen scavenger comprising an oxidizable polymer and a transition metal catalyst.

8-11. (canceled)

12. The multilayer packaging film of claim 1, wherein the second polymeric layer comprises at least about 0.01 wt. percent of the functional additive.

13-14. (canceled)

15. The multilayer packaging film of claim 1, wherein the first and third polymeric layers each comprise a least one functional additive, wherein the functional additive of the first polymeric layer and the functional additive the third polymeric layer are both different than the functional additives in the second polymeric layer.

16-17. (canceled)

18. The multilayer packaging film of claim 1, wherein second polymeric layer further comprises a second functional additive.

19-20. (canceled)

21. The multilayer packaging film of claim 1, wherein the average molecular weight of the thermoplastic polymer in the second polymeric layer is different than the average molecular weight of the thermoplastic polymer in the first polymeric layer and the third polymeric layer.

22. The multilayer packaging film of claim 21, wherein the melt flow properties of the thermoplastic polymer in the second polymeric layer are the same as the melt flow properties of the thermoplastic polymer in the first polymeric layer.

23. (canceled)

24. The multilayer packaging film of claim 1, wherein the thermoplastic polymer in the second polymeric layer exhibits a process induced polymer chain orientation that is different than a polymer chain orientation in the first polymeric layer and the third polymeric layer.

25. (canceled)

26. The multilayer packaging film of claim 1, wherein the first layer and the third layer are directly bonded to the second layer via an ultrasonic welding process.

27. The multilayer packaging film of claim 1, wherein the film comprises at least two distinct zones overlapping interfaces between layers; wherein the two zones exhibit a property that is different than adjacent areas of the multilayer packaging film, wherein the property is selected from the group consisting of density, crystallinity, optical clarity, stiffness, a mechanical property, a rheological property, or an optical property;
wherein the two zones overlap interfaces where layers meet. 28-34. (canceled)

35. The multilayer packaging film of claim 1, wherein the multilayer packaging film exhibits oxygen transmission rate (OTR) of less than 1 cc/100 in²-day at 73° F., 0% RH, and 1 atm as measured per ASTM D3985.

36-37. (canceled)

38. The multilayer packaging film of claim 1, wherein the multilayer packaging film exhibits a water vapor transmission rate (WVTR) of less than 1 cc/100 in²/day at 100° F., 90% RH as measured per ASTM F1249.

39-41. (canceled)

42. The multilayer packaging film of claim 1, wherein the multilayer film lacks adhesives and tie layers.

43-44. (canceled)

45. The multilayer packaging film of claim 1, further comprising
a fourth polymeric layer;
a fifth polymeric layer contacting the fourth polymeric layer; and
a sixth polymeric layer contacting the fifth polymeric layer;
wherein the fourth polymeric layer contacts the first polymeric layer or the third polymeric layer, or the sixth polymeric layer contacts the first polymeric layer or the third polymeric layer.

46. The multilayer packaging film of claim 1, wherein the fourth polymeric layer is the same as the first polymeric layer; the fifth polymeric layer is the same as the second polymeric layer; and the sixth polymeric layer is the same as the third polymeric layer.

47. The multilayer packaging film of claim 45, further comprising
a seventh polymeric layer;
an eighth polymeric layer contacting the seventh polymeric layer; and
a ninth polymeric layer contacting the eighth polymeric layer;
wherein the seventh polymeric layer contacts the fourth polymeric layer or the sixth polymeric layer, or the ninth polymeric layer contacts the fourth polymeric layer or the sixth polymeric layer.

48. The multilayer packaging film of claim 47, wherein the seventh polymeric layer is the same as the first polymeric layer; the eighth polymeric layer is the same as the second polymeric layer; and the ninth polymeric layer is the same as the third polymeric layer.

49-51. (canceled)

52. A packaged food product comprising:
a package formed of a multilayer packaging film, the multilayer packaging film comprising
a first polymeric layer;
a second polymeric layer; and
a third polymeric layer;
wherein the first layer and the third layer directly contact opposite sides of the second layer;
wherein the first layer and the third layer are directly bonded to the second layer via a welding process;
wherein the first polymeric layer, the second polymeric layer, and the third polymeric layer each comprise the same thermoplastic polymer;
wherein the second polymeric layer comprises a weight percent amount of a functional additive that is different than the first and third polymeric layers; and
a food material disposed in the package.
